(19) United States
(12) Patent Application Publication
(10) Pub. No.: US 2021/0089911 A1
(43) Pub. Date: Mar. 25, 2021

(54) METHOD, COMPUTER SYSTEM AND COMPUTER PROGRAM FOR CONTROLLING AN ACTUATOR

(71) Applicant: Robert Bosch GmbH, Stuttgart (DE)

(72) Inventors: Christoph Schorn, Leonberg (DE); Jaroslaw Topp, Renningen (DE); Lydia Gauerhof, Sindelfingen (DE); Stefan Gehrer, Pittsburgh, PA (US)

(21) Appl. No.: 17/041,798

(22) PCT Filed: Apr. 2, 2019
(86) PCT No.: PCT/EP2019/058258

§ 371 Date: Sep. 25, 2020

(30) Foreign Application Priority Data
Apr. 18, 2018 (DE) 102018205869.5

(51) Int. Cl. G06N 3/08; G06N 3/063; G06F 11/07

(52) U.S. Cl. CPC G06N 3/08; G06F 11/0796; G06F 11/0739; G06N 3/063

(57) ABSTRACT

A method for controlling an actuator. The method includes: mapping parameters of a trained machine learning system that have a magnitude from a first set of different possible magnitudes to a magnitude of at least one predefinable second set of different possible magnitudes; storing the converted parameters in a memory block in each case; ascertaining an output variable of the machine learning system as a function of an input variable and the stored parameters. The stored parameters are read out from the respective memory block with the aid of at least one mask. The actuated is actuated as a function of the ascertained output variable. A computer system, a computer program, and a machine-readable memory element in which the computer program is stored are also described.

### FIELD

The present invention relates to a method for controlling an actuator as a function of an output variable of a machine learning system. The present invention also relates to a computer system for controlling the actuator and to a computer program, which is set up to carry out the present method.

### BACKGROUND INFORMATION

German Patent Application No. DE 10 2011 087 791 A1 describes a method in a maneuvering assistance system in vehicles as well as corresponding maneuvering assistance systems. The method includes the steps of detecting a situation according to which a driver of the vehicle wants to perform a manual operation in relation to an object, and aiding in the alignment of the vehicle in relation to the object.

### SUMMARY

During the operation of a neural network, signal interference may occur within the neural network, which can lead to a false classification. This may have serious consequences if safety-critical applications are involved, e.g., when the presence of an object in the traffic scene is unable to be detected in a realistic manner with the aid of the neural network adversely affected by signal interference. In contrast, example embodiments of the present invention have the advantage that parameters of a deep neural network are read out from a memory with the aid of masks so that disturbances, in particular flipped bits, in the memory may have a less serious effect on the operation of the deep neural network.

In a first aspect of the present invention, a method is provided for controlling an actuator. In accordance with an example embodiment of the present invention, among other things, the method includes steps having the following features:
Mapping parameters of a trained machine learning system. The parameters, each having a magnitude of a first set of different possible magnitudes, are mapped to a magnitude of at least one predefinable second quantity of different possible magnitudes in each case. The second set of different possible magnitudes has fewer magnitudes than the first set of different possible magnitudes.
Storing the mapped parameters in a memory block in each case.
Ascertaining an output variable of the machine learning system as a function of an input variable and the stored parameters. The stored parameters are read out from the respective memory block with the aid of a mask.

A trained machine learning system is a machine learning system which was trained with the aid of predefinable training data for the purpose of solving a specifiable task, e.g., to segment an image or to classify an input variable.

One advantage of this aspect of the present invention is that a reduction in the required memory for storing the parameters is able to be achieved by reducing the number of possible different magnitudes, e.g., a value or an at least one-dimensional vector. In addition, hand-in-hand with the reduction of the number of different magnitudes, it is also possible to reduce the number of bits required to represent the different magnitudes. For this reason, not all bits of a register are required any longer for storing the respective magnitude in the register. Only the bits required to represent the stored magnitude in the memory block are read out with the aid of the mask so that, for instance, flipped bits that could have occurred in the bits not required to represent the stored magnitude do not change the originally stored parameter due to the masked readout of the register. This has the advantageous effect that greater robustness of the machine learning system with regard to hardware-side disturbances that may be caused by high-energy radiation, for example, is able to be achieved.

Another advantage is that since a parameter is stored in a memory block in each case, only one parameter is read out incorrectly in the event of a control flow error. In the following text, a control flow error is meant to describe that an incorrect register is read out. In addition, fewer different errors may occur because of the reduced number of different magnitudes, with the result that the potential number of different errors is able to be restricted.

It is advantageous if a maximum magnitude of the first set of different possible magnitudes is greater than a maximum magnitude of the second set of different possible magnitudes. This has the advantage that due to smaller maximum magnitudes, the absolute maximum error becomes smaller if a bit error disturbance occurs in one of the bits required to represent the maximum magnitude, and a smaller maximum magnitude is able to be stored in the memory using fewer bits.

It is furthermore advantageous if magnitudes, in particular intermediate magnitudes, ascertained when ascertaining the output variable of the machine learning system, are checked to see whether they are greater than a maximum magnitude. If a magnitude of the machine learning system is greater than a maximum magnitude when ascertaining the output variable of the machine learning system, then the output variable of the machine learning system is marked as faulty. This makes it possible to detect disturbances or errors in a timely manner.

The example method of the first aspect of the present invention is able to be used in a physical-technical system, e.g., a robot or an at least semi-autonomous vehicle, which includes an actuator. A control unit may use the ascertained output variable in order to control the actuator as a function of this output variable. Toward that end, the control unit may determine a control variable as a function of the ascertained output variable and use it for the control of the actuator.

According to a further aspect of the present invention, a computer system is provided, in particular for controlling the actuator. In accordance with an example embodiment of the present invention, the computer system includes at least one processor, which is connected to a memory module. A computer program is stored in the memory module, and at least parameters of a machine learning system are stored in memory blocks of the memory module, in particular registers. Among other things, the computer system is set up to read out the parameters from the respective memory block with the aid of at least one mask.

This has the advantage that only the bits for representing the parameter are read out from the memory with the aid of the mask, which means that bits that are not required to represent the parameter are not read out because of the masking and no disturbances of these bits therefore occur either.

It is advantageous if a predefinable number of the memory blocks is subdivided into a plurality of segments in each case, and at least one of the parameters is stored in each segment. The mask takes only the particular bits of the respective segment into account that are required to represent a maximum magnitude of the second predefinable set, or the mask takes only the particular bits of the respective memory block into account that are required in each segment in order to represent the maximum magnitude. This offers the advantage that the memory is used in an efficient manner while the advantage of the masking is retained.

It is furthermore advantageous if the machine learning system includes a deep neural network. The magnitudes of the particular parameters that are allocated to a layer, especially a neuron, of the deep neural network are mapped to one of the magnitudes of the respective allocated set of different possible magnitudes of this layer, especially neuron. The computer system is furthermore set up to use different masks for reading out the parameters of the respective layers, especially neurons.

This has the advantage that the mask is flexibly adaptable for the respective different layers or neurons. A corresponding mask is thus able to provide greater accuracy and/or a greater value range for the respective layer or neuron.

According to a further aspect of the present invention, an example computer program is provided, which is set up to carry out one of the previously mentioned methods. The computer program includes instructions that induce a computer or the computer system according to the further aspect to carry out one of these mentioned methods with all of its steps when the computer program is running on the computer/computer system. In addition, a machine-readable memory medium is provided in which the computer program is stored.

Exemplary embodiments of the present invetion are illustrated in the figures and are described in greater detail below.

### BRIEF DESCRIPTION OF THE DRAWINGS

FIG. 1 shows a schematic illustration of an at least semi-autonomous vehicle in accordance with an example embodiment of the present invention.

FIG. 2 shows a schematic illustration of a hardware-oriented number representation format with and without a flipped bit disturbance, and mapping of values of a first value range to a second value range, in accordance with an example embodiment of the present invention.

FIG. 3 shows a schematic illustration of a specific embodiment of a computer system in accordance with an example embodiment of the present invention.

FIG. 4 shows a schematic illustration of a specific embodiment of the present method for controlling an actuator in accordance with the present invention.

### DETAILED DESCRIPTION OF EXAMPLE EMBODIMENTS

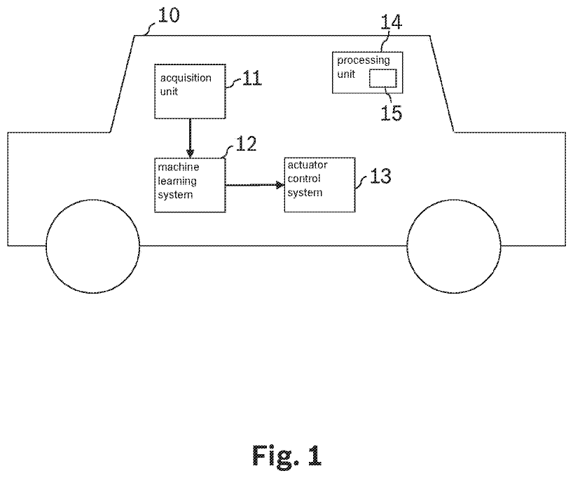

FIG. 1 shows a schematic illustration of an at least semi-autonomous robot, which is an at least semi-autonomous vehicle (10) in the exemplary embodiment. In a further exemplary embodiment, the at least semi-autonomous robot could be a service robot, an assembly robot or a stationary production robot. The at least semi-autonomous vehicle (10) may include an acquisition unit (11). The acquisition unit (11), for example, may be a camera, which detects an environment of the vehicle (10). The acquisition unit (11) is able to be connected to a machine learning system (12). The machine learning system (12) ascertains an output variable as a function of a supplied input variable, e.g., using acquisition unit (11), and as a function of a plurality of magnitudes characterizing the machine learning system. The output variable is able to be forwarded to an actuator control unit (13). The actuator control unit (13) is capable of actuating an actuator as a function of the output variable of the machine learning system (12). The actuator in this exemplary embodiment may be a motor of the vehicle (10).

In a further exemplary embodiment, actuator control unit (13) includes an enabling system. The enabling system decides whether an object such as a detected robot or a detected person has access to an area as a function of the output variable of the machine learning system (12). The actuator is preferably able to be actuated as a function of a decision by the enabling system.

In addition, vehicle (10) includes a processing unit (14) and a machine-readable memory element (15). Storable in memory element (15) is a computer program, which includes instructions that cause the processing unit (14) to carry out the method according to the present invention when the instructions are executed in the processing unit (14). It is also possible that a download product or an artificially generated signal, each possibly including the computer program, induces the processing unit (14) to carry out the method according to the present invention after being received at a receiver of the vehicle (10).

In one further specific embodiment, the machine learning system (12) is used in a measuring system, which is not shown in the figures. The measuring system differs from the robot according to FIG. 1 insofar as the measuring system does not include an actuator control unit (13). Instead of forwarding the output variable of machine learning system (12) to actuator control unit (13), the measuring system is able to store and display it, for instance using visual or auditive representations.

It is also possible that in a further development of the measuring system, acquisition unit (11) acquires an image of a human or animal body or a part thereof. For instance, this may be accomplished with the aid of an optical signal, an ultrasonic signal, or with the aid of an MRI/CT method. In this further development, the measuring system may include a machine learning system that is trained so that it outputs a classification as a function of the input variable, e.g., which clinical picture may possibly be present on the basis of this input variable.

Machine-learning system (12) may encompass a deep neural network.

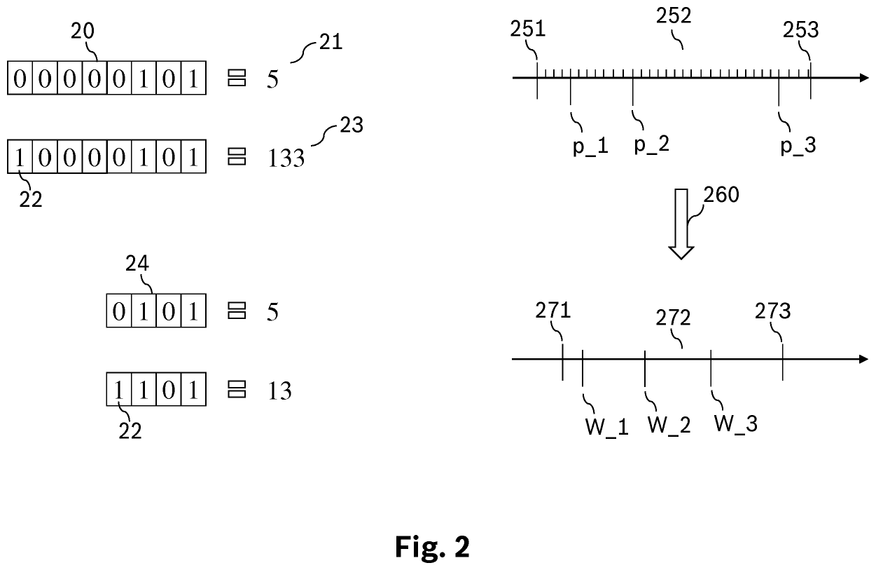

FIG. 2 shows a schematic illustration of a hardware-oriented number representation format (20,24). A first hardware-oriented number representation format (20), a binary system having 8 bits, represents a value 5 (21) using eight different place values. A disruption, e.g., a flipped bit in a register in which the value 5 (21) is stored using the first hardware-oriented number representation format (20), may lead to a change in one of the place values (22). This flipped bit disruption is shown in FIG. 2 by way of example; here, the most significant place value (22) is inverted in the first hardware-oriented number representation format (20). This disruption may have the result that value 133 (23) instead of value 5 (21) will now be stored in the register.

In a second hardware-oriented number representation format (24), such as a binary system using 4 bits, a disruption in the most significant place value (22) has the result that the value 13 will now be stored rather than the value 5.

Based on this example, it becomes clear that a restriction of the maximally tolerated value range of the hardware-oriented number representation format and the related reduction in the required bits necessary to represent the restricted value range may lead to a reduction of the maximum error of a flipped bit disturbance. Therefore, it is advantageous if parameters of the machine learning system are represented using few bits, which means that flipped bits lead to a smaller change in the value represented by these bits.

In addition, FIG. 2 schematically shows different value ranges (252,272) of parameters of the machine learning system. The parameters of the trained deep neural network have values from a first value range (252) in each case. The first value range (252) includes a first set of different possible values (p_1,p_2,p_3), which may encompass a minimum value (251) and a maximum value (253).

Using predefinable mapping (260), the values of the parameters are mapped to a second value range (272) in such a way that the values are able to be represented by fewer bits. Second value range (272) encompasses a predefinable set of different possible values (w_1,w_2,w_3) and may extend between two predefinable values (271,273).

Preferably, a maximum value (p_3) of the set of different possible values (p_1,p_2,p_3) of the first value range (252) is greater than a maximum value (w_3) of the set of different possible values (w_1,w_2,w_3) of the second value range (272).

In one further specific embodiment, a difference between two, in particular directly consecutive values (w_2,w_3) of the second value range (272) is smaller than a difference between two, in particular directly consecutive values (p_2,p_3) of the first value range (252) that are mapped to these two consecutive values (w_2,w_3). Because of the small difference between two different values, the difference from the original value may be small when the flipped bit disturbance occurs, which means that the resulting error has a negligible influence on the machine learning system.

In one alternative exemplary embodiment, the machine learning system (12) may include a convolutional neural network. The parameters may then also be filter kernels. In this exemplary embodiment, coefficients of the filter kernels are able to be mapped from a first value range (252) to a second value range (272). As an alternative or in addition, whole filter kernels are also mappable to predefinable filter kernels, which, for instance, are able to be represented by a reduced number of bits.

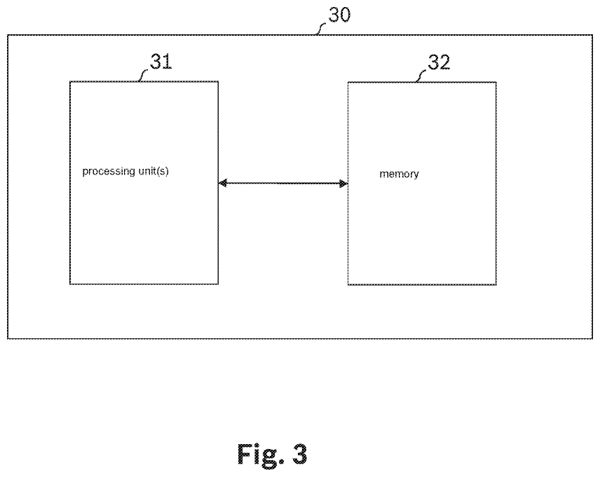

FIG. 3 shows a schematic representation of a computer system (30), which is preferably set up to operate the machine learning system and in particular is set up to control an actuator as a function of an output variable of the machine learning system (12). The computer system (30) includes at least one processing unit (31), which is connected to a memory (32). A software and parameters of a machine learning system are stored in the memory (32). In addition, further information about the machine learning system, e.g., its architecture, may also be stored in the memory (32).

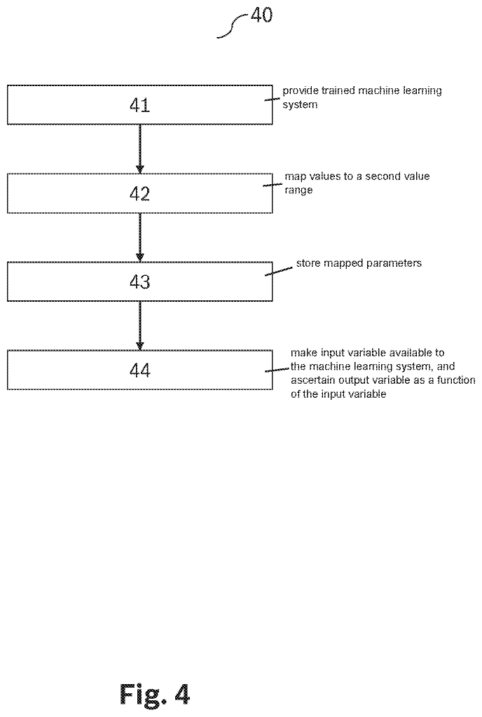

FIG. 4 shows a schematic representation of a method (40) for controlling the actuator.

The method (40) begins with step 41. In step 41, a trained machine learning system (12) is provided. The parameters of the trained machine learning system have values of the first value range (252). In step 42, these values are subsequently mapped to a second value range (272). The mapping of the values of the parameters is able to be carried out in such a way that the values are mapped to a value of a predefinable set of different possible values (w_1,w_2,2_3) in each case. For instance, a value of the parameter of the trained machine learning system that lies closest to one of the different possible values (w_1,w_2,w_3) of the predefinable set according to a mathematical distance measure is able to be mapped thereto.

The predefinable set of different possible values (w_1,w_2,w_3) is able to be ascertained with the aid of a cluster analysis (e.g., k-means algorithm) of the values of the parameters of the provided machine learning system (12).

Alternatively, it is also possible to provide a plurality of predefinable sets of different possible values (w_1,w_2,w_3), e.g., featuring different quantization stages in each case. Using a Kullback-Leibler (KL) divergence, which is ascertained between one of the predefinable sets and the distribution of the values of the parameters of the provided machine learning system, it is possible to select the set having the lowest ascertained KL divergence from the plurality of predefinable sets of different possible values (w_1,w_2,w_3). The KL divergence characterizes a loss of information that occurs when the values are mapped to a smaller value range. The particular set that has the lowest KL distance may then be used for mapping the values of the parameters of the provided machine learning system to values of this set.

In one further exemplary embodiment, the maximum value (w_3) of the different possible values (w_1,w_2,w_3) is able to be predefined, preferably smaller than the maximum possible value of the parameters of the provided machine learning system, in order to further restrict the value range of the predefinable set of different possible values (w_1,w_2,w_3). The maximum value (w_3) may also be taken into account in the ascertainment of the KL divergence in order to determine a suitable maximum value (w_3) that leads to a small loss of information.

Step 43 follows after the parameters of the trained machine learning system have been mapped to the second value range (272). In step 43, the mapped parameters are stored in a memory element of the memory (32) in each case.

In following step 44, an input variable is made available to the machine learning system and an output variable of the machine learning system is ascertained as a function of the input variable. The input variable, for instance, may be a video recording or a camera image of the environment of the actuator. The machine learning system ascertains an output variable as a function of the provided input variable and the stored parameters. In the process, the stored parameters are read out from the memory with the aid of a mask. The mask reads out only the particular bits of the memory element that are required in order to represent the maximum value (w_3) of the different possible values (w_1,w_2,w_3).

The mask may be implemented in software, e.g., by a bit sequence that is made up of zeroes and ones. The bit sequence is linked with the bits of the memory element by a logic AND operation. The mask is alternatively able to be implemented in hardware.

For example, if the register includes 8 bits and the maximum value (w_3) of the different possible values (w_1,w_2,w_3) is able to be represented by the rear four bits, then the mask is able to link the not required front four bits to a 0 using a logic AND operation, so that the flipped bit disturbances of these bits do not lead to an incorrectly read out parameter from the register. Thus, it would still be possible to read out the originally stored number 5 in FIG. 2 even if the number 133 has been incorrectly stored in the 8 bit register.

After the output variable of the machine learning system has been ascertained, an actuator, e.g., the motor of an at least semi-autonomous vehicle, is able to be actuated with the aid of the actuator control unit (13). For instance, if machine learning system (12) detects a person, then actuator control unit (13) is able to actuate the actuator so that it decelerates the vehicle (10).

Method (40) thus ends. Alternatively or additionally, it is possible to carry out the method anew in a cyclical manner by step 44, for instance if a new camera image was detected or a trigger was triggered in that regard.

It is understood that the present method is able to be implemented not only entirely in software, as described, but also in hardware or in a mixed form of software and hardware.

1-11. (canceled)

12. A method for controlling an actuator, comprising the following steps:
mapping parameters of a trained machine learning system which have a magnitude from a first set of different possible magnitudes to a magnitude of at least one predefinable second set of different possible magnitudes, in each case, the second set of different possible magnitudes having fewer magnitudes than the first set of different possible magnitudes;
storing each of the mapped parameters in a respective memory block;
ascertaining an output variable of the machine learning system as a function of an input variable and the stored parameters, each of the stored parameters being read out from the respective memory block using at least one mask, and only particular bits of the respective memory block are taken into account using the mask that are required to represent a maximum magnitude of the second set of different possible magnitudes; and
actuating the actuator as a function of the ascertained output variable.

13. The method as recited in claim 12, wherein a maximum magnitude of the first set of different possible magnitudes is greater than the maximum magnitude of the second set of different possible magnitudes.

14. The method as recited in claim 12, wherein the machine learning system includes a deep neural network, magnitudes of parameters that are allocated to a layer of the deep neural network are mapped to one of a plurality of magnitudes of a respective allocated set of different possible magnitudes of the layer, different masks being used for reading out the parameters for respective layers of the deep neural network.

15. The method as recited in claim 12, wherein each of a predefinable number of the memory blocks is subdivided into a plurality of segments, and one of the parameters is stored in each segment, wherein the mask takes only particular bits of the respective segment into account that are required to represent the second maximum magnitude, or the mask takes only particular bits of the particular memory block into account that are required in each segment to represent the second maximum magnitude.

16. The method as recited in claim 12, wherein the mask is made up of a predefinable bit sequence, and the bit sequence has the same number of bits as a memory block, and during the readout, each bit of the memory block is logically linked with at least one respective allocated bit of the mask.

17. The method as recited in claim 12, wherein when a magnitude of the machine learning system is greater than the maximum magnitude when ascertaining the output variable of the machine learning system, the output variable of the machine learning system is marked as faulty.

18. A computer system, comprising:
at least one processor which is connected to a memory module, a computer program being stored in the memory module and at least parameters of a machine learning system are stored in respective memory blocks of the memory module, the respective memory blocks being registers, wherein the machine learning system is trained on a further computer system and after the training, a magnitude of the parameters from a first set of different possible magnitudes is mapped to a magnitude of at least one predefinable second set of different possible magnitudes, he second set of different possible magnitudes has fewer magnitudes than the first set of different possible magnitudes;
wherein the computer program, when executed, is configured to read out each of the parameters from the respective memory block using at least one mask and to take only particular bits of the respective memory block into account using the mask that are required to represent a maximum magnitude of the second set of different possible magnitudes.

19. The computer system as recited in claim 18, wherein the machine learning system includes a deep neural network, magnitudes of parameters that are allocated to a layer of the deep neural network are mapped to one of the magnitudes of a respective allocated set of different possible magnitudes of the layer, the computer system furthermore being configured to use different masks for reading out parameters for respective layers of the deep neural network.

20. The computer system as recited in claim 18, wherein a maximum magnitude of the first set of different possible magnitudes is greater than the maximum magnitude of the second set of different possible magnitudes, each of a predefinable number of the memory blocks being subdivided into a plurality of segments, and one of the parameters being stored in each segment, the mask taking only particular bits of the respective segment into account that are required to represent the second maximum magnitude, or the mask taking only particular bits of the respective memory block into account that are required in each segment to represent the second maximum magnitude.

21. A non-transitory machine-readable memory element on which is stored a computer program for controlling an actuator, the computer program, when executed on a computer, causing the computer to perform the following steps:
mapping parameters of a trained machine learning system which have a magnitude from a first set of different possible magnitudes to a magnitude of at least one predefinable second set of different possible magnitudes, in each case, the second set of different possible magnitudes having fewer magnitudes than the first set of different possible magnitudes;
storing each of the mapped parameters in a respective memory block;
ascertaining an output variable of the machine learning system as a function of an input variable and the stored parameters, each of the stored parameters being read out from the respective memory block using at least one mask, and only particular bits of the respective memory block are taken into account using the mask that are required to represent a maximum magnitude of the second set of different possible magnitudes; and
actuating the actuator as a function of the ascertained output variable.
